(19) United States
(12) Patent Application Publication
(10) Pub. No.: US 2025/0048364 A1
(43) Pub. Date: Feb. 6, 2025

(54) DATA RECEPTION METHOD, DATA TRANSMISSION METHOD AND APPARATUSES THEREOF

(71) Applicant: FUJITSU LIMITED, Kawasaki-shi (JP)

(72) Inventors: Qinyan JIANG, Beijing (CN); Lei ZHANG, Beijing (CN)

(73) Assignee: FUJITSU LIMITED, Kawasaki-shi (JP)

(21) Appl. No.: 18/925,538

(22) Filed: Oct. 24, 2024

Related U.S. Application Data
(63) Continuation of application No. PCT/CN2022/090099, filed on Apr. 28, 2022.

(51) Int. Cl. H04W 72/1273; H04W 72/232

(52) U.S. Cl. CPC H04W 72/1273; H04W 72/232

(57) ABSTRACT

A data reception apparatus, applicable to a terminal equipment, includes: processor circuitry configured to allocate PDCCH candidates for a first search space, the first search space being used to schedule cells in a first set; and a transceiver configured to receive DCI in the first search space, the DCI being used to schedule at least two cells in the first set.

### CROSS-REFERENCE TO RELATED APPLICATION

This application is a continuation application of International Application PCT/CN2022/090099 filed on Apr. 28, 2022, and designated the U.S., the entire contents of which are incorporated herein by reference.

### TECHNICAL FIELD

This disclosure relates to the field of communication technologies.

### BACKGROUND

A physical downlink shared channel (PDSCH) is one of physical downlink channels used in a wireless communication system to carry downlink data. A physical uplink shared channel (PUSCH) is one of physical uplink channels used in a wireless communication system to carry uplink data. The PDSCH and PUSCH may be scheduled by downlink control information (DCI).

In an existing new radio (NR) system, multiple DCI formats for scheduling PDSCHs or PUSCHs are defined, and included specific information and/or sizes of DCI in different DCI formats are different, so as to meet different scheduling demands.

A concept of control resource set (CORESET) is introduced in NR. CORESET is time-frequency resources corresponding to monitoring occasions of PDCCHs, and a search space (SS) defines monitoring occasions and search behaviors in the monitoring occasions. That is, PDCCH configuration is a combination of a CORESET and an SS.

A serving cell may configure one or more bandwidth parts (BWPs) in both uplink and downlink. The CORESET and SS are configured in a downlink bandwidth part (DL BWP), but the configured CORESET and SS are indexed within per serving cell. ABWP may configure multiple CORESETs and SSs. Except for CORESET index #0, the configuration of a CORESET includes an index of the CORESET. Except for SS index #0, the configuration of an SS includes an index of the SS and an index of a CORESET to which the SS corresponds. A CORESET may be associated with multiple SSs, that is, configurations of different SSs may include identical CORESET indices. According to the above configurations, a terminal equipment may learn a combination of CORESETs and SSs, thereby determining configuration of the PDCCH.

In order to transmit a DCI, a network device needs to perform cyclic redundancy check (CRC) attachment, channel coding, rate matching, scrambling, modulation, etc., on a DCI payload of the DCI, and map it onto a physical resource to which a PDCCH candidate corresponds; and correspondingly, the terminal equipment monitors the PDCCH candidate, so as to receive the DCI.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

At present, radio resource control configures a carrier (cell) to perform self-scheduling or cross-carrier scheduling. Self-scheduling refers to scheduling a PDSCH and/or PUSCH on a carrier by DCI transmitted on the carrier; and cross-carrier scheduling refers to scheduling a PDSCH and/or PUSCH on a carrier (cell) by DCI transmitted on another carrier (cell).

Currently, DCI only supports scheduling one serving cell, including situations where self-scheduling and cross-carrier scheduling are concerned. In order to alleviate a burden of a terminal equipment in monitoring DCI and lower power consumption and complexity, an NR system will support scheduling PDSCHs and/or PUSCHs of multiple serving cells by one DCI. However, there is currently no solution on how to support scheduling PDSCHs and/or PUSCHs of multiple serving cells by one DCI, such as how to determine which PDCCH candidates to be monitored to detect DCI transmitted on the PDCCH candidates in a case where a DCI schedules multiple serving cells, etc.

In order to solve at least one of the above problems, embodiments of this disclosure provide a data reception method, a data transmission method and apparatuses thereof.

According to one aspect of the embodiments of this disclosure, there is provided a data reception apparatus, applicable to a terminal equipment, the apparatus including:
a processing unit configured to allocate PDCCH candidates for a first search space, the first search space being used to schedule cells in a first set; and
a receiving unit configured to receive DCI in the first search space, the DCI being used to schedule at least two cells in the first set.

According to another aspect of the embodiments of this disclosure, there is provided a data transmission apparatus, applicable to a network device, the apparatus including:
a transmitting unit configured to transmit DCI in a first search space, the first search space being used to schedule cells in a first set, the DCI being used to schedule at least two cells in the first set, and the first search space being allocated with PDCCH candidates for transmitting the DCI.

According to a further aspect of the embodiments of this disclosure, there is provided a communication system, including a network device and/or a terminal equipment, the network device including the data transmission apparatus described in the one aspect of the embodiments of this disclosure, and the terminal equipment including the data reception apparatus described in the other aspect of the embodiments of this disclosure.

An advantage of the embodiments of this disclosure exists in that which PDCCH candidates are monitored in which search spaces may be determined for a case where one DCI schedules multiple cells, so as to support scheduling multiple cells by one DCI, thereby alleviating a burden of the terminal equipment in performing DCI monitoring, and lowering power consumption and complexity.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/comprising/including/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of embodiments of this disclosure;

FIG. 2A is a schematic diagram of a CORESET of embodiments of this disclosure;

FIG. 2B is a schematic diagram of a PDCCH monitoring occasion of embodiments of this disclosure;

FIG. 3 is a schematic diagram of CCE configuration of a serving cell of embodiments of this disclosure;

FIG. 4 is a schematic diagram of a data reception method of embodiments of this disclosure;

FIGS. 5-24 are schematic diagrams of a first PDCCH candidate set of embodiments of this disclosure;

FIG. 25 is a schematic diagram of meanings of parameters of embodiments of this disclosure;

FIGS. 26 and 27 are schematic diagrams of allocating PDCCH candidates of embodiments of this disclosure;

FIG. 28 is a schematic diagram of a data transmission method of embodiments of this disclosure;

FIG. 29 is a schematic diagram of a data reception apparatus of embodiments of this disclosure;

FIG. 30 is a schematic diagram of a data transmission apparatus of embodiments of this disclosure;

FIG. 31 is a schematic diagram of a terminal equipment of embodiments of this disclosure; and

FIG. 32 is a schematic diagram of a network device of embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a wearable device, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” may refer to a network device, and may also refer to a terminal equipment, except otherwise specified.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable. The terms “cell”, “carrier”, “serving cell”, “carrier component” and “serving carrier” are interchangeable. The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable. The terms “DCI” and “DCI format” are interchangeable.

In addition, transmitting or receiving a PUSCH may be understood as transmitting or receiving uplink data carried by the PUSCH, transmitting or receiving a PUCCH may be understood as transmitting or receiving uplink information (e.g. UCI) carried by the PUCCH, transmitting or receiving a PRACH may be understood as transmitting or receiving a preamble carried by the PRACH. Transmitting or receiving a PDSCH may be understood as transmitting or receiving downlink data carried by the PDSCH, and transmitting or receiving a PDCCH may be understood as transmitting or receiving downlink information (e.g. DCI) carried by the PDCCH.

In the embodiments of this disclosure, higher-layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

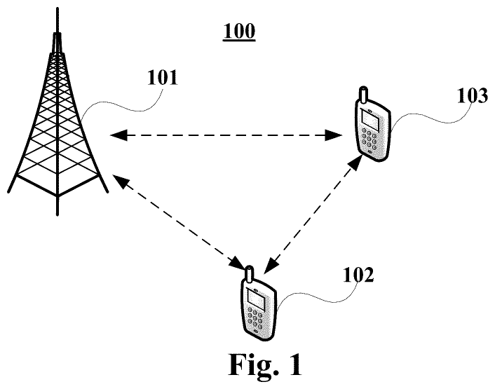

FIG. 1 is a schematic diagram of a communication system of embodiments of this disclosure, in which a case where terminal equipments and a network device are taken as examples is schematically shown. As shown in FIG. 1, the communication system 100 may include a network device 101 and terminal equipments 102, 103. For the sake of simplicity, an example having only two terminal equipments and one network device is schematically given in FIG. 1; however, the embodiments of this disclosure are not limited thereto.

In the embodiments of this disclosure, existing services or services that may be implemented in the future may be performed between the network device 101 and the terminal equipment 102, 103. For example, such services may include but not limited to an enhanced mobile broadband (eMBB), massive machine type communication (MTC), ultra-reliable and low-latency communication (URLLC), and related communications of reduced capability terminal equipment, etc.

It should be noted that FIG. 1 shows that two terminal equipments 102, 103 are both in coverage of the network device 101. However, this disclosure is not limited thereto, and the two terminal equipment 102, 103 may not be in coverage of the network device 101, or one terminal equipment 102 is in coverage of the network device 101 and the other terminal equipment 103 is out of coverage of the network device 101.

A PDCCH candidate is determined based on CORESET configuration and SS configuration.

The CORESET configuration, SS configuration and a method for determining a PDCCH candidate shall be exemplified below.

### For the CORESET Configuration

Configuration of a CORESET other than CORESET #0 may include at least the following information fields:
controlResourceSetId, which indicates a CORESET index;
frequencyDomainResources, which indicates resources of the CORESET in a frequency domain;
duration, which indicates a duration of the CORESET, such as continuous symbol data;
cce-REG-MappingType, which indicates a mode of mapping a CCE to an REG, such as interleaving mapping or non-interleaving mapping;
precoderGranularity, which indicates a mode of mapping a DMRS in a PDCCH, for example, when “precoderGranularity” indicates allContiguousRBs, a DMRS associated with a PDCCH to which it corresponds is broadband mapping, that is, the DMRS associated with the PDCCH occupies all REGs in the CORESET; otherwise, the DMRS associated with the PDCCH to which it corresponds is narrowband mapping, that is, the DMRS associated with the PDCCH only occupies REGs occupied by the PDCCH;
in addition, reference may be made to existing techniques for other relevant information fields in configurations of CORESETs other than CORESET #0, which are not limited in this disclosure.

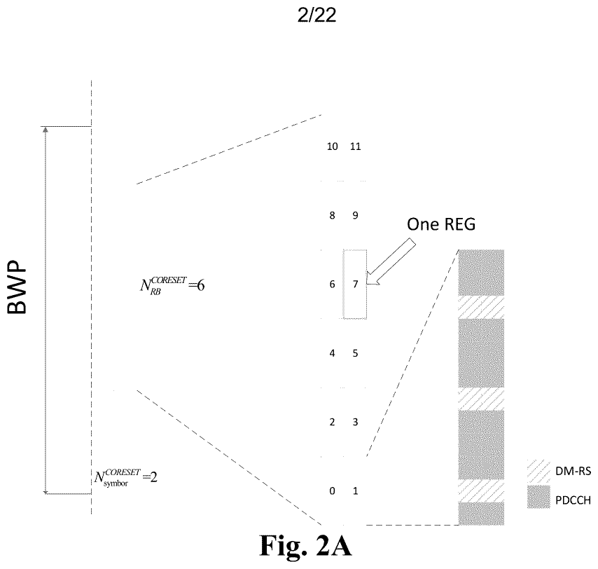

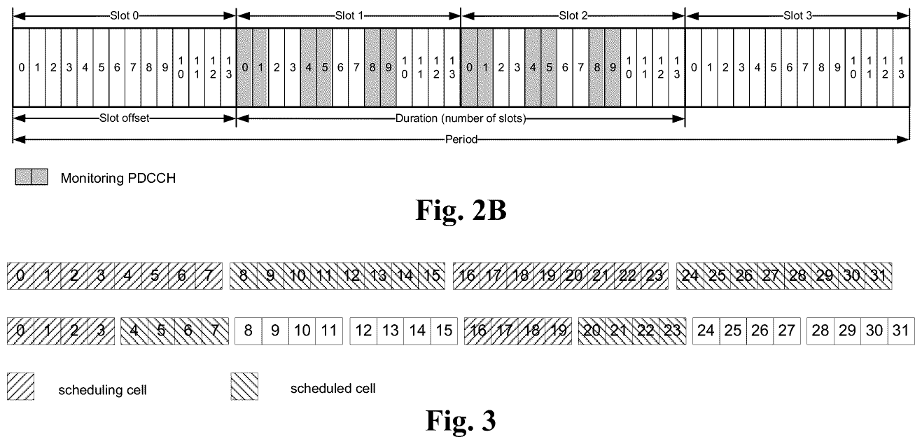

FIG. 2A is a schematic diagram of the CORESET of embodiments of this disclosure. A control channel element (CCE) for allocating PDCCH channel resources is a basic unit constituting the PDCCH. In NR, one CCE occupies 6 REGs, each corresponding to 12 resource elements (REs) on a physical resource block (RB), wherein one REG has 9 PDCCH data REs and 3 DRMS REs, hence, in REG0 and REG1 shown in FIG. 2, there are 18 PDCCH data REs and 6 DRMS REs respectively. In addition, mapping between the CCEs and REGs may be achieved in such modes as interleaving mapping and non-interleaving mapping, etc. Reference may be made to existing techniques for a particular manner of mapping, which is not limited in this disclosure.

In addition, the number of CCEs in the PDCCH is referred to as aggregation level (AL) or aggregation degree. In transmitting the PDCCH, according to an actual wireless channel environment, the network device 101 may determine how many aggregation levels are used to transmit control information. For example, when the wireless channel environment is harsh, using a large aggregation degree may achieve relatively good demodulation performance; and when the wireless channel environment is relatively good, a relatively smaller aggregation degree is used.

As shown in FIG. 2A, for example, relevant parameters in the CORESET configuration are N_{RB}^{CORESET}=6,N_{symb}^{CORESET}=2, that is, one CORESET occupies 6 RBs in the frequency domain and 2 symbols in the time domain. For the current CORESET, there are total 2 CCEs. Assuming that AL=2, a transmitted PDCCH includes 2 CCEs, and for CCE-to-REG mapping, the interleaving and non-interleaving mapping methods are identical.

### For SS Configuration

Configuration of SS other than SS #0 may include at least the following information fields:
searchSpaceId, which indicates an SS index;
monitoringSlotPeriodicityAndOffset, which indicates a PDCCH monitoring period (in a unit of a slot) and a slot offset from the start of the monitoring period to an actual detection search space;
controlResourceSetId, which indicates a CORESET index to which the SS corresponds; duration, which indicates the number of consecutive PDCCH monitoring slots in a PDCCH monitoring period, the PDCCH monitoring slot referring to a slot in which the PDCCH candidate needs to be monitored;
monitoringSymbolsWithinSlot, which indicates a starting symbol of a PDCCH monitoring occasion in a PDCCH monitoring slot, for example, there are total 14 bits, a highest bit therein denoting a first symbol, and so on;
nrofCandidates, which indicates the number of PDCCH candidates, such as indicating the number of corresponding PDCCH candidates for different ALs; and
searchSpaceType, which indicates a type of a search space, such as a common search space (CSS), or a UE-specific search space (USS).

FIG. 2B is a schematic diagram of the PDCCH monitoring occasion of the embodiments of this disclosure.

As shown in FIG. 2B, it is assumed that,
the CORESET to which controlResourceSetId corresponds includes 2 symbols.
Periodicity: 4 slots
Duration: 2 slots
monitoringSymbolsWithinSlot:10001000100000.

The terminal equipment is able to determine the PDCCH monitoring occasion.

In addition, reference may be made to existing techniques for relevant information fields other than SS #0 in the configuration of SS, which are not limited in this disclosure.

For search space configuration and CORESET configuration associated therewith, the terminal equipment may determine time-frequency domain resources where PDCCHs are monitored. In order to reduce complexity of blind detection of the PDCCHs by a UE, configuration information for configuring the number of PDCCH candidates is further provided in the search space configuration. Thus, when the UE blindly detects PDCCHs/DCI at one PDCCH monitoring occasion of a search space, it may determine that there are multiple corresponding PDCCH candidates for one or more aggregation levels and CCEs to which the PDCCH candidates correspond.

For example, for an active DL BWP of a subcarrier spacing μ of a serving cell f, a slot n_{s,f}^{μ} and a CCE index corresponding to a PDCCH candidate m_{s,n}_{_{CI}} of an aggregation level L in a search space (or search space set) s of an associated CORESET p are provided by a formula as below:

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ {N}_{CCE , p} / L ⌋ \} + i ; \qquad ( 1 )$$

where, i={0, 1, . . . , L−1}, Y_{p,n}_{_{s,f}}_{^{μ}}, denoting a frequency-domain starting position of the PDCCH candidate set, and reference may be made to existing techniques for specific parameters and contents thereof, which are not limited in this disclosure; N_{CCE,p} denotes the number of CCEs in CORESET p; n_{CI} is a value of carrier indication, wherein for cross-carrier scheduling, a value of carrier indication of a scheduled cell/carrier is notified to the terminal equipment by high-level signaling, such as an IE “CrossCarrierSchedulingConfig” in the RRC signaling, the value of carrier indication of the scheduling cell/carrier is predefined as 0, and values of carrier indication to which different cells correspond, i.e. values n_{CI} to which different carriers correspond, are different. Therefore, it may be ensured that PDCCH candidate sets of different carriers may possibly occupy non-overlapped CCEs as much as possible, thereby avoiding PDCCH blocking caused by resource conflicts. If there exists no cross-carrier scheduling or for CSS, its value is 0; m_{s,n}_{_{CI}}^{(L)} is a PDCCH candidate index, m_{s,n}_{_{CI}}^{(L)}=0, . . . , M_{s,n}_{_{CI}}^{(L)}, where, M_{s,n}_{_{CI}}^{(L)} denotes the search space s, the aggregation level is L, corresponding to the number of PDCCH candidates of a serving cell of n_{CI}, where, s is an SS index; M_{s,max}^{(L)} denotes the number of PDCCH candidates of the search space s with the aggregation level L; for CSS, M_{s,max}^{(L)}=M_{s,0}^{(L)}, and for USS, it is a maximum value of M_{s,n}_{_{CI}}^{(L)} within a range of all values of n_{CI} with the aggregation level L in CORESET p in the search space s.

Assuming that Y_{p,n}_{_{s,f}}_{^{μ}}=0 and N_{CCE,p}=32, for each serving cell (there are total two serving cells), the number of PDCCH candidates on each AL (it is assumed here that each serving cell is only configured with AL=4, 8) is shown in Table 1. According to formula (1), the CCE indices corresponding to the PDCCH candidates to which each serving cell corresponds are shown in FIG. 3.

In the related art, one serving cell is able to schedule two serving cells, but is only able to schedule one serving cell in one DCI. For example, assuming that Y_{p,n}_{_{s,f}}_{^{μ}}=0,N_{CCE,p}=32, for each serving cell (there are total two serving cells), the number of PDCCH candidates on each AL is shown in Table 1. CCEs of PDCCH candidates to which each serving cell corresponds are shown in FIG. 3.

TABLE 1
Number of PDCCH candidates of each AL of each serving cell

| AL | Scheduling cell (n_{CI} = 0) | Scheduled cell (n_{CI} = 1) |
|---|---|---|
| 4 | 2 | 2 |
| 8 | 2 | 2 |

The above method is designed for scheduling only one cell by one DCI, in which a corresponding PDCCH candidate set may be configured and determined for each serving cell, and DCI for scheduling PDSCHs/PUSCHs of each serving cell may be transmitted/received at PDCCH candidates in a corresponding set.

In the technique of monitoring PDCCH candidates, a limit on the number (maximum number) of PDCCH candidates and a limit on the number (maximum number) of non-overlapped CCEs within one time unit are defined for a single cell. The time unit is, for example, a slot, a span (including some symbols within a slot), and a slot group (including more than one slot). Taking that a first time unit is a slot as an example, the limit on the number (maximum number) of PDCCH candidates is M_{PDCCH}^{max,slot,μ}, and the limit on the number (maximum number) of non-overlapped CCEs is C_{PDCCH}^{max,slot,μ}; where μ denotes an SCS of the PDCCH, and slot refers to a slot to which μ corresponds. Exceeding the above limits by the number of configured PDCCH candidates and the number of the non-overlapped CCEs is referred to as overbooking. The terminal equipment discards a search space set with a highest index, until the limit on the number of PDCCH candidates and the limit on the number of non-overlapped CCEs are satisfied. In an NR system of R15, slot-level limits on number of PDCCH candidates and number of non-overlapped CCEs are adopted, that is, the network device or terminal equipment determines within a slot whether the above limits are satisfied. If they are not satisfied, the search space set with a highest index in the slot is discarded. In NR systems of R16/R17, span-level/slot group-level limits on number of PDCCH candidates and number of non-overlapped CCEs may possibly adopted. Correspondingly, the network device or terminal equipment determines within a span/slot group whether corresponding limit on the number (maximum number) of PDCCH candidates and the limit on the number (maximum number) of non-overlapped CCEs are satisfied. If they are not satisfied, a search space set with a highest index within the span/slot group is discarded.

NR systems support single carrier or carrier aggregation (CA/DC). At present, as it is only taken into account that one DCI is only able to schedule one cell, the number of PDCCH candidates and the number of non-overlapped CCEs are counted or allocated respectively for each cell. Taking a slot level as an example, for example, for a cell, in a slot (PDCCH monitoring slot), the terminal equipment monitors no more than min(C_{PDCCH}^{max,slot,μ},C_{PDCCH}^{total,slot,μ}) non-overlapped CCEs and no more than min(M_{PDCCH}^{max,slot,μ},M_{PDCCH}^{total,slot,μ}) PDCCH candidates in an ascending order of CSS and USS indices (from a perspective view of priorities, regardless of a specific monitoring time-domain order). That is, for this cell, the terminal equipment preferentially monitors CSS(s) and USS(s) with smaller index value(s). If the number of PDCCH candidates and non-overlapped CCEs of a USS lead to that a total number of PDCCH candidates of the USS, USS(s) with index value(s) smaller than the index value of the USS, and the CSS exceeds min(M_{PDCCH}^{max,slot,μ},M_{PDCCH}^{total,slot,μ}) and/or a total number of non-overlapped CCEs exceeds min(C_{PDCCH}^{max,slot,μ},C_{PDCCH}^{total,slot,μ}), the PDCCH candidates of the USS are not monitored, or the PDCCH candidates are not monitored in the USS, or PDCCH candidates are not allocated to (not for) the USS.

However, the above monitoring method is for the case where one DCI is only able to schedule one cell. There is currently no method for determining which PDCCH candidates are monitored in which search spaces (sets) for cases where one DCI scheduled multiple serving cells.

Following description shall be given with reference to embodiments.

### Embodiments of a First Aspect

The embodiments of this disclosure provide a data reception method, which shall be described from a terminal equipment side.

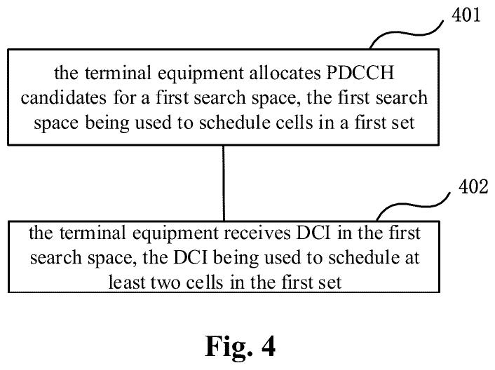

FIG. 4 is a schematic diagram of a data reception method of the embodiments of this disclosure. As shown in FIG. 4, the method includes:
401: the terminal equipment allocates PDCCH candidates for a first search space, the first search space being used to schedule cells in a first set; and
402: the terminal equipment receives DCI in the first search space, the DCI being used to schedule at least two cells in the first set.

In some embodiments, the terminal equipment may receive search space configuration information and CORESET configuration information transmitted by a network device, and may determine a PDCCH candidate set included in the first search space or a PDCCH candidate set included in a CORESET to which the first search space corresponds according to the search space configuration information and CORESET configuration information, i.e. determining a CCE index (CCE starting position and the number of CCEs) in the CORESET of each PDCCH candidate in the PDCCH candidate set. The first search space is used to schedule cells in the first set, and the first search space is on one cell of the first set or is not on any cell of the first cell set. At least one PDCCH candidate in the PDCCH candidate set is used to transmit the DCI, and the DCI schedules at least two cells in the first set. The first search space may be a UE-specific search space (USS) or a common search space (CSS).

In some embodiments, that the first search space is used for scheduling cells in the first set refers to that in a case where a limit on the number of PDCCH candidates and a limit on the number of non-overlapped CCEs are not exceeded, the UE monitors the PDCCH candidates in the first search space to receive the DCI for scheduling one or more cells in the first set. Correspondingly, the network device may map or transmit the DCI for scheduling one or more cells in the first set on the PDCCH candidates in the first search space. After the PDCCH candidate set included in the first search space is determined, in 401, PDCCH candidates need to be allocated for the first search space, including determining whether to allocate PDCCH candidates for the first search space (or, in other words, whether to monitor PDCCH candidates in the first search space, or whether to monitor PDCCH candidates of the first search space), and/or determining the number N of PDCCH candidates allocated for the first search space (or, in other words, the number N of PDCCH candidates monitored in the first search space), or determining whether to monitor PDCCH candidates in the PDCCH candidate set, or determining which PDCCH candidates in the PDCCH candidate set are monitored. In 402, the allocated PDCCH candidate to which the first search space corresponds are monitored, so as to receive the DCI mapped onto the above PDCCH candidates and transmitted.

For the convenience of description, concepts of a set, a group, a combination and a cell concerned in this disclosure shall be explained first.

In some embodiments, the first set includes all cells of the first search space used for scheduling, and may include a scheduling cell and at least one scheduled cell (i.e. the first search space is on a cell in the first set, and the cell is the scheduling cell), or may include at least two scheduled cells (i.e. the first search space is not on any cell in the first set). In the case where a scheduling cell is included, the scheduling cell may schedule a PDSCH and/or a PUSCH on the scheduled cell, or the scheduling cell may schedule a PDSCH and/or a PUSCH of its own (self scheduling); and a cell where the first search space is located may be a primary cell or a secondary cell, and the scheduling cell and the scheduled cell may be primary cells or secondary cells, and the embodiments of this disclosure are not limited thereto.

In some embodiments, being used for scheduling a cell may also be referred to as being used for scheduling a PDSCH and/or a PUSCH on a cell, or scheduling a PDSCH and/or a PUSCH on a cell by DCI received on the cell. Or, that the DCI is used for scheduling a cell may also be referred to as that the DCI is used for scheduling a PDSCH and/or a PUSCH on the cell. DCI used for scheduling a PDSCH may be referred to as downlink assignment, and DCI used for scheduling a PUSCH may be referred to as uplink grant.

In some embodiments, the first cell refers to any cell in the first set, and the second cell refers to a first reference cell in the first set, wherein the first reference cell is a reference cell used to allocate PDCCH candidates, and different second cells are associated or not associated with the same cell. The third cell refers to a second reference cell in the first set, wherein the second reference cell is a reference cell used to determine cells in the first set, and different third cells are associated or not associated with the same cell. The third cell, the second cell and the first cell are identical or different. The first group and the second group refer to subsets of the first set (divided by any means), and the first combination and the second combination may be understood as a specific subset. Cells in a combination may be scheduled by the same DCI simultaneously (at once time). The first group and/or the first combination is/are used in allocating PDCCH candidates, and the second group and/or the second combination are used in determining PDCCH candidates. The first group and the second group are identical or different, and the first combination and the second combination are identical or different. A group or combination may include one or more cells, different first groups have or do not have intersections, different first combinations have or do not have intersections, different second groups have or do not have intersections, and different second combinations have or do not have intersections. Different second groups or different second combinations include or do not include the same cell.

The PDCCH candidate set included in the first search space (including total M4 PDCCH candidates) shall be described below.

In some embodiments, the PDCCH candidate set includes one or more first PDCCH candidate sets, and different first PDCCH candidate sets include or do not include PDCCH candidates with identical CCEs, wherein the first PDCCH candidate sets are for individual cells or for cell groups. For example, all the first PDCCH candidate sets are for individual cells, or all the first PDCCH candidate sets are for cell groups, or a part of the PDCCH candidate sets are for individual cells, and other parts thereof are for cell groups.

For example, the first PDCCH candidate set is for the first set, or for a first cell in the first set, or for a third cell in the first set, or for a second group in the first set, or for a second combination in the first set or a second group, or for a set of second combinations. Or, in other words, the first PDCCH candidate set is divided in a granularity of the first set, or the first cell in the first set, or the third cell in the first set, or the second group in the first set, or the second combination in the first set or the second group, or the set of second combinations.

For example, for the first set, all PDCCH candidates corresponding to the first set, and/or all first cells in the first set, and/or all third cells in the first set, and/or all second groups in the first set, or all second combinations in the first set or all the second groups, are included.

For the first cell, all PDCCH candidates corresponding to the first cell are included.

For the third cell, all PDCCH candidates corresponding to the third cell are included.

For the second group, all PDCCH candidates corresponding to the second group, or all first cells in the second group, or all third cells in the second group, or the second combination in the second group, are included.

For the second combination in the first set or the second group, all candidates corresponding to the second combination are included.

The PDCCH candidates corresponding to the first cell refer to PDCCH candidates used to transmit the DCI for scheduling the first cell. Here, being used for scheduling the first cell includes: being used for single scheduling the first cell and/or for simultaneously scheduling the first cell and other cells in the first set. The PDCCH candidates to which different first cells correspond have or do not have an intersection.

The PDCCH candidates to which the third cell corresponds refer to candidates used to transmit DCI that is used for scheduling the third cell and/or cells with which the third cell is associated. Here, being used for scheduling the third cell and/or cells with which the third cell is associated includes: being used for scheduling only the third cell and/or the cells with which the third cell is associated, and/or for simultaneously scheduling the third cell and/or the cells with which the third cell is associated and other cells in the first set. The PDCCH candidates to which different third cells correspond have or do not have an intersection.

The PDCCH candidates to which the first set corresponds refer to candidates used to transmit DCI that is used for scheduling cells in the first set, or candidates used to transmit DCI that is used for scheduling the first set, or candidates used to transmit DCI that is used for scheduling any second combination in the first set, or candidates used to transmit DCI that is used for scheduling any second group in the first set.

The PDCCH candidate to which the second group corresponds refer to PDCCH candidates used to transmit DCI that is used for scheduling cells in the second group, or PDCCH candidates used to transmit DCI that is used for scheduling the second group, or PDCCH candidates used to transmit DCI that is used for scheduling any second combination in the second group. Here, being used for scheduling the cells in the second group includes: being used for scheduling only the cells in the second group and/or for simultaneously scheduling the cells in the second group and other cells in the first set.

The PDCCH candidates to which the second combination corresponds refer to PDCCH candidates used to transmit DCI that is used for scheduling the second combination.

Following description shall be given with reference to the accompanying drawings.

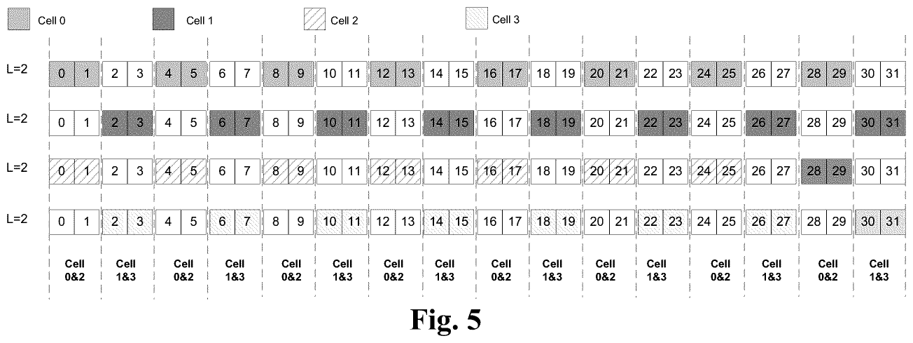

1) The First PDCCH Candidate Set for the First Cell Shall be Described Below with Reference to FIGS. 5-8.

As shown in FIGS. 5-8, the PDCCH candidate set of the first search space includes four first PDCCH candidate sets, wherein a first PDCCH candidate set 0 includes a candidate used to transmit DCI that is used for scheduling cell 0 (first cell 0), a first PDCCH candidate set 1 includes a PDCCH candidate used to transmit DCI that is used for scheduling cell 1 (first cell 1), a first PDCCH candidate set 2 includes a PDCCH candidate used to transmit DCI that is used for scheduling cell 2 (first cell 2), and a first PDCCH candidate set 3 includes a PDCCH candidate used to transmit DCI that is used for scheduling cell 3 (first cell 3), and these sets have an intersection.

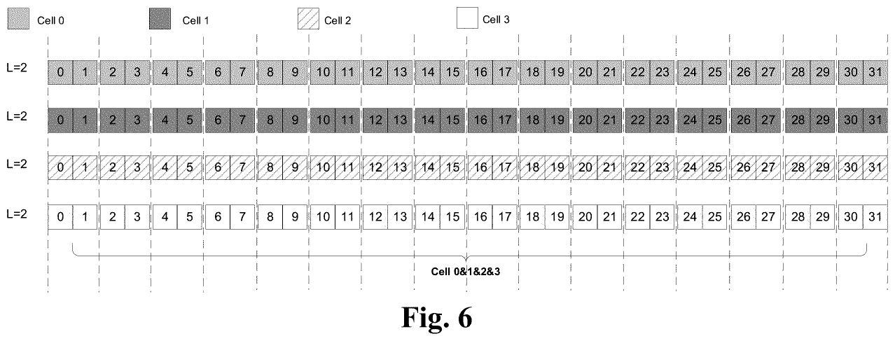

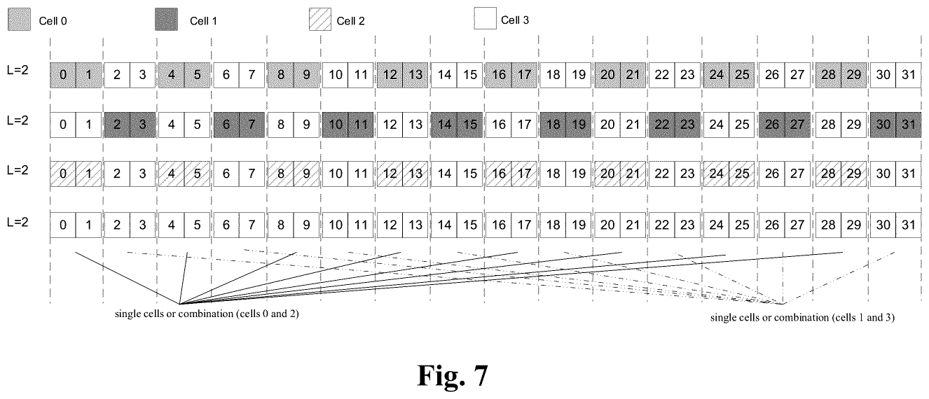

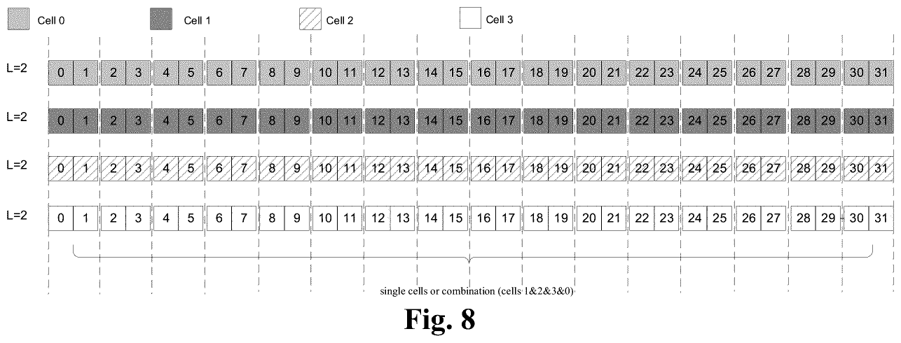

As shown in FIGS. 5 and 6, if a PDCCH candidate corresponds to multiple first cells, the PDCCH candidate is used to transmit DCI that is used for simultaneously scheduling the multiple cells. As shown in FIGS. 7 and 8, if a PDCCH candidate corresponds to multiple first cells, the PDCCH candidate is used to transmit DCI that is used for scheduling a cell or a combination in the multiple cells, and the cell or combination is not any cell or any combination of cells in the multiple cells.

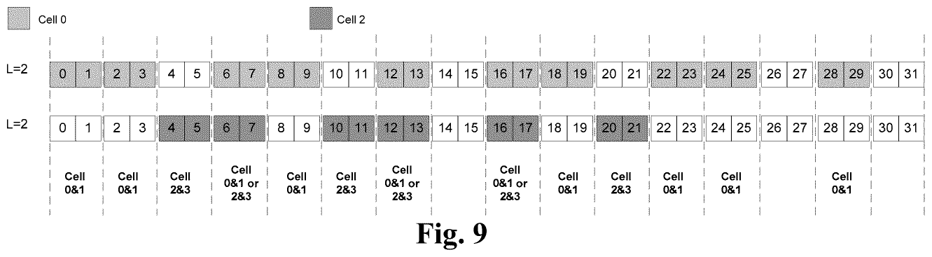

2) The First PDCCH Candidate Set for the Third Cell Shall be Described Below with Reference to FIGS. 9-12

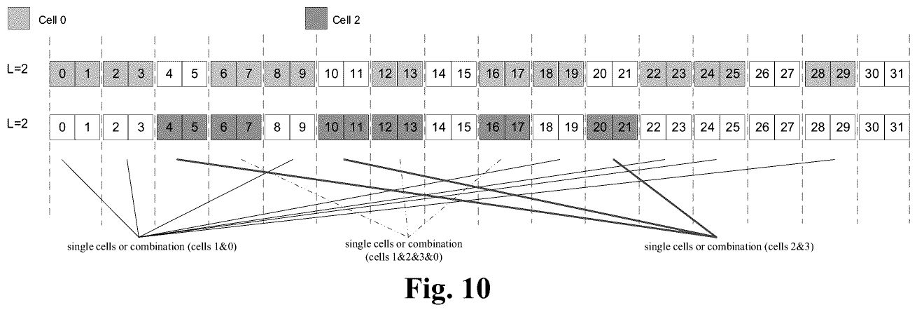

As shown in FIGS. 9-10, the PDCCH candidate set of the first search space includes two first PDCCH candidate sets, wherein a first PDCCH candidate set 0 includes a candidate used to transmit DCI that is used for scheduling cell 0 (third cell 0) and cells associated therewith, and a first PDCCH candidate set 1 includes a candidate used to transmit DCI that is used for scheduling cell 2 (third cell 1) and cells associated therewith. An intersection exists or does not exist in different cells with which the third cell are associated. The above sets have or do not have an intersection.

As shown in FIG. 9, when an intersection exists in the above sets, a third cell and cells associated therewith are always scheduled simultaneously, that is, cell 0&cell 1 are always scheduled simultaneously, and cell2&cell 3 are always scheduled simultaneously, i.e. a third cell is unable to be single scheduled by one DCI. As shown in FIG. 10, no intersection exists in the above sets, a third cell and cells associated therewith may be scheduled simultaneously or separately, that is, a third cell and cells associated therewith may be single scheduled by one DCI.

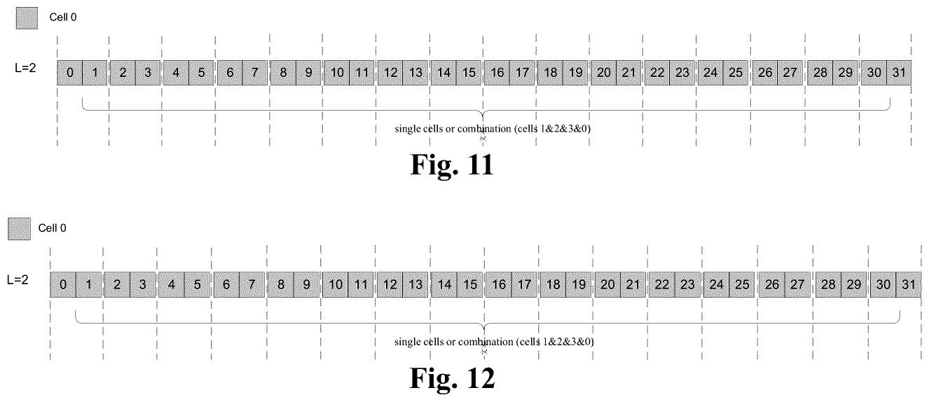

As shown in FIGS. 11 and 12, the PDCCH candidate set of the first search space includes a first PDCCH candidate set, including PDCCH candidates used to transmit DCI that is used for scheduling cell 0 (third cell 0) and cells associated therewith.

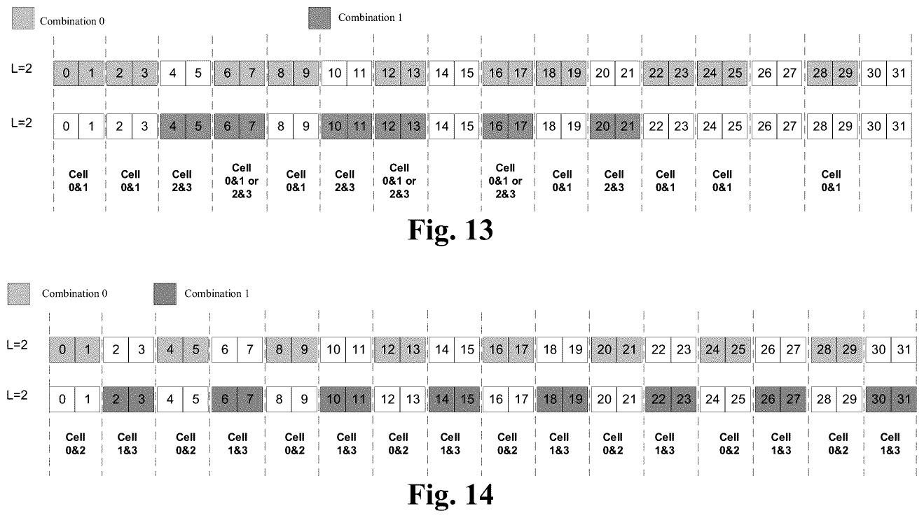

3) The First PDCCH Candidate Set for the Second Combination Shall be Described Below with Reference to FIGS. 13-15.

As shown in FIGS. 13 and 14, the PDCCH candidate set of the first search space includes two first PDCCH candidate sets, wherein a first PDCCH candidate set 0 includes candidates used to transmit DCI that is used for scheduling combination 0, and a first PDCCH candidate set 1 includes candidates used to transmit DCI that is used for scheduling combination 1. An intersection exists or does not exists in set 0 and set 1. As shown in FIG. 13, there exists an intersection, combination 0 includes cell 0&cell 1, and combination 1 includes cell 2&cell 3. As shown in FIG. 14, there exists no intersection, combination 0 includes cell 0& cell 2, and combination 1 includes cell 1&cell 3.

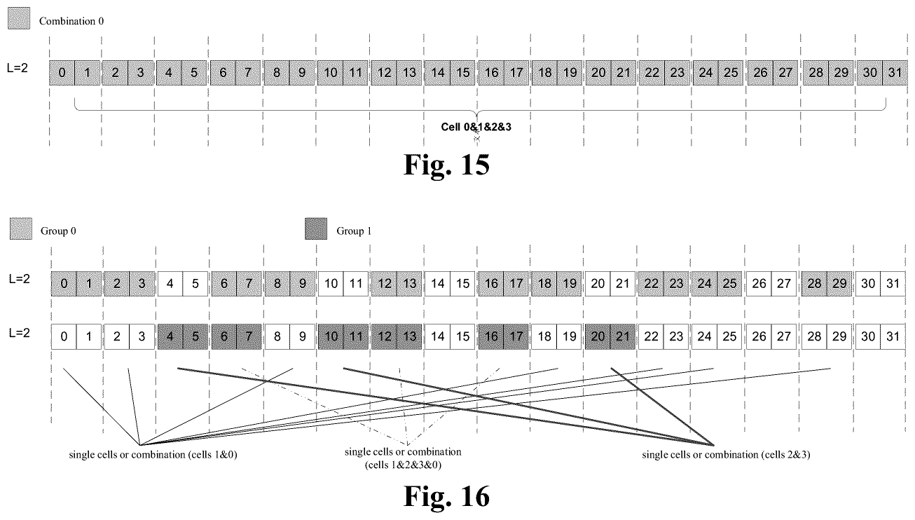

As shown in FIG. 15, the PDCCH candidate set of the first search space shown in the figure below includes one first PDCCH candidate set, including PDCCH candidates used to transmit DCI that is used for scheduling cells of combination 0, and combination 0 includes cell 0&cell 1&cell 2&cell 3.

4) The First PDCCH Candidate Set for the Second Group Shall be Described Below with Reference to FIGS. 16-22

As shown in FIGS. 16-20, the PDCCH candidate set of the first search space includes two first PDCCH candidate sets, wherein a first PDCCH candidate set 0 includes PDCCH candidates used to transmit DCI that is used for scheduling cells in group 0, and a first PDCCH candidate set 1 includes PDCCH candidates used to transmit DCI that is used for scheduling cells in group 1. An intersection exists or does not exist in set 0 and set 1.

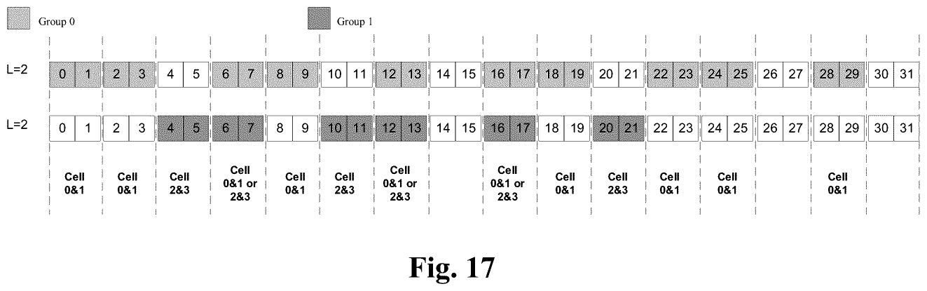

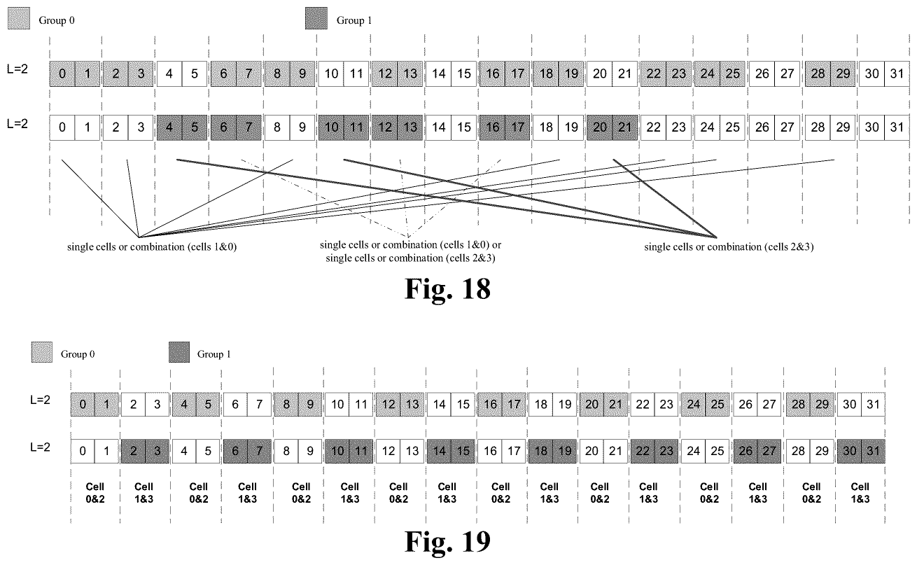

As shown in FIGS. 16-18, set 0 and set 1 have an intersection, wherein PDCCH candidates in the intersection are used to transmit DCI for scheduling a cell in a union of group 0 (cell 0&cell 1) and group 1 (cell 2&cell 3). As shown in FIG. 16, a cell in group 0 and a cell in group 1 may be scheduled by the same DCI. And as shown in FIGS. 17 and 18, a cell in group 0 and a cell in group 1 may not be scheduled by the same DCI.

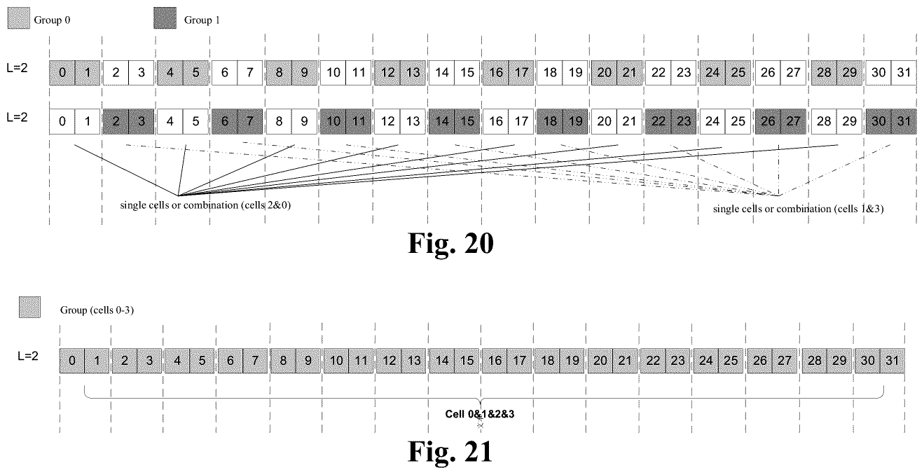

As shown in FIGS. 19 and 20, no intersection exists in set 0 and set 1. As shown in FIG. 19, group 0 includes cell 0&cell 2, and group 1 includes cell 1&cell 3. As shown in FIG. 20, PDCCH candidate in set 0 are used to transmit DCI that is used for scheduling a cell or group 0, and PDCCH candidates in set 1 are used to transmit DCI that is used for scheduling a cell or group 1.

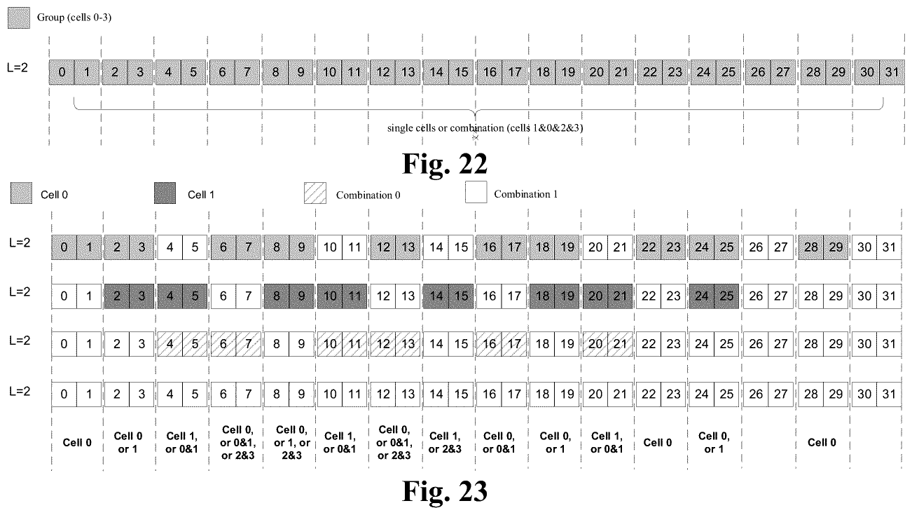

As shown in FIGS. 21 and 22, the PDCCH candidate set of the first search space includes a first PDCCH candidate set, which includes PDCCH candidates used to transmit DCI that is used for scheduling cells in group 0 (cell 0&cell 1&cell 2&cell 3).

5) A First PDCCH Candidate Set for the First Cell and the Second Combination Shall be Described Below with Reference to FIG. 23.

As shown in FIG. 23, the PDCCH candidate set of the first search space includes four first PDCCH candidate sets, wherein a first PDCCH candidate set 0 includes a PDCCH candidate used to transmit DCI that is used for scheduling cell 0 (first cell 0), a first PDCCH candidate set 1 includes a PDCCH candidate used to transmit DCI that is used for scheduling cell 1 (first cell 1), a first PDCCH candidate set 2 includes a PDCCH candidate used to transmit DCI that is used for scheduling combination 0 (cell 0&cell 1), and a first PDCCH candidate set 3 includes a PDCCH candidate used to transmit DCI that is used for scheduling combination 1 (cell 2&cell 3), and these sets have or do not have an intersection.

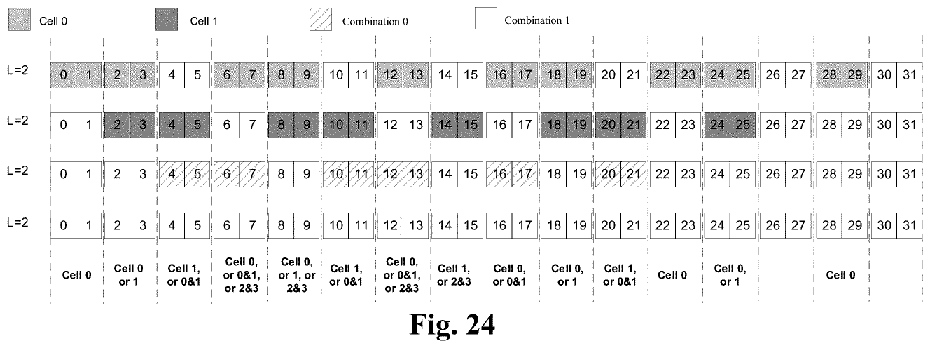

6) A First PDCCH Candidate Set for the First Cell and the Second Group Shall be Described Below with Reference to FIG. 24.

As shown in FIG. 24, the PDCCH candidate set of the first search space includes four first PDCCH candidate sets, wherein a first PDCCH candidate set 0 includes a PDCCH candidate used to transmit DCI that is used for scheduling cell 0 (first cell 0), a first PDCCH candidate set 1 includes a PDCCH candidate used to transmit DCI that is used for scheduling cell 1 (first cell 1), a first PDCCH candidate set 2 includes a PDCCH candidate used to transmit DCI that is used for scheduling group 0, and a first PDCCH candidate set 3 includes a PDCCH candidate used to transmit DCI that is used for scheduling group 1, and these sets have or do not have an intersection. Group 0 and group 1 include or do not include cell 0 and/or cell 1. For example, if group 0 includes cell 1, a PDCCH candidate in the PDCCH candidate set to which group 0 corresponds is not used to schedule single cell 0, or, if the PDCCH candidate set corresponding to cell 0 has an intersection, only PDCCH candidates in the intersection may be used to schedule single cell 0.

Above 1)-6) are examples only, and the aggregation level is L=2 in the examples; however, the embodiments of this disclosure are not limited thereto, which shall not be enumerated herein any further.

It is described above that in determining PDCCH candidate sets, each first PDCCH candidate set is divided in a granularity of a single cell and/or cell group. For example, the first PDCCH candidate set is for the first set, or the first cell in the first set, or the third cell in the first set, or the second group in the first set, or the second combination in the first set or the second group, or the set of second combinations.

In allocating PDCCHs, they may also be allocated at a granularity of individual cells or cell groups. For example, the PDCCH candidates are allocated for one or more of the following: the first set, the first cell (in the first set), the second cell (in the first set), the first group (in the first set), the first combination (in the first set or the first group), and a set of the first combinations (in the first set or the first group).

In some embodiments, granularity for determining the PDCCH candidates and granularity for allocating the PDCCH candidates are identical. For example, in determining the first PDCCH candidate set in a granularity of the first set, the PDCCH candidates may also be allocated in a granularity of the first set. However, this is an example only, and the embodiments of this disclosure are not limited thereto.

In some embodiments, the terminal equipment allocates the PDCCH candidates according to one or more of the following parameters: a first parameter, a second parameter, a third parameter, a fourth parameter, a fifth parameter, and a sixth parameter. The first parameter and/or the second parameter and/or the third parameter and/or the fourth parameter and/or the fifth parameter and/or the sixth parameter is/are for the first set, or the first cell in the first set, or a second cell in the first set, or a first group in the first set, or the first combination in the first set or the first group, or a set of the first combinations (in the first set or the first group).

The above parameters shall be explained first.

In some embodiments, the first parameter M1 denotes a first number M1 of PDCCH candidates, the first number of PDCCH candidates being the number of PDCCH candidates that are able to be allocated. The first parameter M1 is for the first set, or the first cell in the first set, or a second cell in the first set, or the first group in the first set, or the first combination in the first set or the first group or a set of first combinations (in the first set or the first group). For example, the first parameter is determined at a granularity of the first set, or the first cell in the first set, or a second cell in the first set, or the first group in the first set, or the first combination in the first set or the first group or a set of first combinations (in the first set or the first group).

In some embodiments, the second parameter M2 denotes a second number of PDCCH candidates, the second number of PDCCH candidates being the number of PDCCH candidates that have been allocated before the first search space. The second parameter M2 is for the first set, or the first cell in the first set, or a second cell in the first set, or the first group in the first set, or the first combination in the first set or the first group or a set of first combinations (in the first set or the first group). For example, the second parameter may be the number of PDCCH candidates that have been allocated by the first search space on the first set, or the first cell in the first set, or a second cell in the first set, or the first group in the first set, or the first combination in the first set or the first group or the set of first combinations (in the first set or the first group), and the second parameter M2 is equal to a sum of numbers of PDCCH candidates allocated for search spaces before the first search space.

In some embodiments, the third parameter M3 denotes a third number of PDCCH candidates, the third number of PDCCH candidates being the number of PDCCH candidates that are able to be allocated for the first search space. The third parameter M3 is for the first set, or the first cell in the first set, or a second cell in the first set, or the first group in the first set, or the first combination in the first set or the first group or a set of first combinations (in the first set or the first group). For example, the third parameter may be equal to the number of PDCCH candidates remained after the number of PDCCH candidates that may be allocated minus the number of PDCCH candidates that have been allocated before the first search space.

In some embodiments, the fourth parameter M4 denotes a fourth number of PDCCH candidates, the fourth number of PDCCH candidates being the number of PDCCH candidates that are included in the first search space. The fourth parameter M4 is for the first set, or the first cell in the first set, or a second cell in the first set, or the first group in the first set, or the first combination in the first set or the first group or a set of first combinations (in the first set or the first group).

How to count the number of PDCCH candidates (fourth parameter) in the PDCCH candidate set included in the first search space shall be described below.

In some embodiments, the terminal equipment allocates PDCCH candidates for the first cell or the second cell or the first group in the first set. At least one cell in the first cell or the second cell or the first group is included in multiple second groups or second combinations, and the fourth parameter for the first cell or the second cell or the first group is determined according to first PDCCH candidate sets to which the multiple second groups or second combinations correspond.

For example, the fourth parameter is equal to the number of PDCCH candidates in a union (second PDCCH candidate set) of the first PDCCH candidate sets to which the multiple second groups or second combinations correspond, that is, 1 is only added in counting for PDCCH candidates with identical CCEs in the first PDCCH candidate sets; or, a sum of respective numbers of PDCCH candidates of the first PDCCH candidate sets to which the multiple second groups or second combinations correspond, it is counted respectively for PDCCH candidates with identical CCEs in each first PDCCH candidate set.

In some embodiments, the terminal equipment allocates PDCCH candidates for the first group in the first set, the first group including multiple second groups or second combinations, and determines the fourth parameter for the first group according to the first PDCCH candidate sets to which the multiple second groups or second combinations correspond.

For example, the fourth parameter is equal to the number of PDCCH candidates in a union (second PDCCH candidate set) of the first PDCCH candidate sets to which the multiple second groups or second combinations correspond, that is, 1 is only added in counting for PDCCH candidates with identical CCEs in the first PDCCH candidate sets, or, a sum of respective numbers of PDCCH candidates of the first PDCCH candidate sets to which the multiple second groups or second combinations correspond, it is counted respectively for PDCCH candidates with identical CCEs in each first PDCCH candidate set.

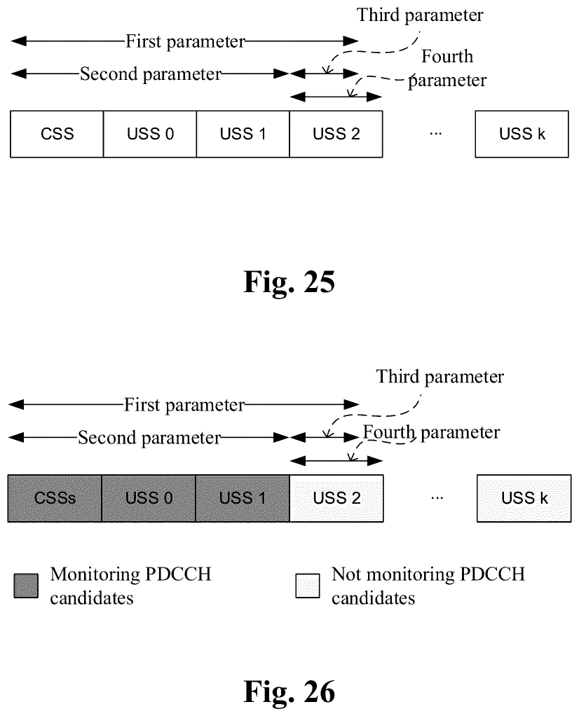

The first parameter, second parameter, third parameter and fourth parameter shall be described below with reference to FIG. 25. As shown in FIG. 25, USS2 is the first search space, CSS(s) (including one or more), USS0 and USS1 are the search spaces before the first search space. The number of PDCCH candidates that have been allocated for the CSS is N1, the number of PDCCH candidates that have been allocated for USS0 is N2, and the number of PDCCH candidates that have been allocated for USS1 is N3. The first parameter M1 is the number of PDCCH candidates that are able to be allocated, and may be determined for the first set, the first cell in the first set, a second cell in the first set, the first group in the first set, and the first combination in the first set or the first group. The second parameter M2 is the number of PDCCH candidates that have been allocated before the first search space, which is equal to N1+N2+N3. The third parameter M3 is the number of PDCCH candidates that are able to be allocated for the first search space, which is equal to M1-M2. And the fourth parameter M4 is a determined number of PDCCH candidates included in the first search space.

In some embodiments, the first parameter may be configured, or the fifth parameter is used to determine the first parameter, and/or, the sixth parameter is used to determine the fourth parameter, the fifth parameter and the sixth parameter are identical or different, and the fifth parameter and/or the sixth parameter is/are predefined or configured. And the fifth parameter and/or the sixth parameter is/are related to the first group and/or the first combination.

In some embodiments, the terminal equipment allocates PDCCH candidates for the first group. The terminal equipment determines the first parameter for the first group according to the fifth parameter and/or the number of cells in the first group and/or the number of PDCCHs that are able to be allocated for a cell. For example, the number of PDCCHs that are able to be allocated for a cell is M_{PDCCH}^{max,T}^{ᵤₙᵢₜ}^{,μ} (predefined or configured), and the first parameter for the first group is determined as P1×min(M_{PDCCH}^{total,T}^{ᵤₙᵢₜ}^{,μ},M_{PDCCH}^{max,T}^{ᵤₙᵢₜ}^{,μ}) - - - formula (2) according to the number N of cells in the first group; or, the fifth parameter is a parameter related to the first group, and the first parameter of the first group is determined according to the fifth parameter. For example, the fifth parameter may be a predefined or configured scaling factor related to the first group, and the first parameter is determined according to a product of the scaling factor and P1×M_{PDCCH}^{max,T}^{ᵤₙᵢₜ}^{,μ} or P1×min(M_{PDCCH}^{total,T}^{ᵤₙᵢₜ}^{,μ}, M_{PDCCH}^{max,T}^{ᵤₙᵢₜ}^{,μ}). For another example, the first parameter is equal to Σᵢ₌₀^{P-1}aᵢM_{PDCCH}^{max,T}^{ᵤₙᵢₜ}^{,μ} or Σᵢ₌₀^{P-1}aᵢmin(M_{PDCCH}^{total,T}^{ᵤₙᵢₜ}^{,μ},M_{PDCCH}^{max,T}^{ᵤₙᵢₜ}^{,μ}); wherein, P1 is the number of cells in the first group, aᵢ is a value of a fifth parameter to which cell i in the first group corresponds. For a further example, the fifth parameter may be a predefined or configured scaling factor, which is used for adjusting M_{PDCCH}^{max,T}^{ᵤₙᵢₜ}^{,μ} or M_{PDCCH}^{total,T}^{ᵤₙᵢₜ}^{,μ}, and the first parameter may be determined by substituting the adjusted M_{PDCCH}^{max,T}^{ᵤₙᵢₜ}^{,μ} or M_{PDCCH}^{total,T}^{ᵤₙᵢₜ}^{,μ} in formula (2); wherein, μ denotes a subcarrier spacing SCS of the PDCCHs, Tᵤₙᵢₜ a refers to a time unit to which μ corresponds, such as a slot, a span (including a part of symbols in a slot), and a slot group (including more than one slots), M_{PDCCH}^{total,T}^{ᵤₙᵢₜ}^{,μ} denotes a maximum number of PDCCH candidates of a cell of a predefined time unit Tᵤₙᵢₜ, and M_{PDCCH}^{total,T}^{ᵤₙᵢₜ}^{,μ} denotes a maximum number of PDCCH candidates of a cell of a time unit Tᵤₙᵢₜ determined according to cell configuration (such as a configured number of downlink cells).

In some embodiments, the terminal equipment allocates PDCCH candidates for the first combination. The terminal equipment determines the first parameter for the first combination according to the fifth parameter and/or the number of cells in the first group and/or the number of PDCCHs that may be allocated for a cell. A method for determining is similar to that for allocating PDCCH candidates for the first group, which shall not be repeated herein any further.

A method of determining the fourth parameter according to the sixth parameter is similar thereto, for example, the sixth parameter is a scaling factor, etc., which shall not be enumerated herein any further.

In the above embodiments, the first parameter, second parameter, third parameter and fourth parameter are all related parameters denoting the number of PDCCH candidates. However, the embodiments of this disclosure are not limited thereto, and the first parameter, second parameter, third parameter and fourth parameter may also be related parameters denoting the number of non-overlapped CCEs, and the above number of PDCCH candidates may be replaced with the number of non-overlapped CCEs, which shall not be enumerated herein any further.

In some embodiments, the method may further include: the terminal equipment reports a capability of the terminal equipment, the capability including the number of cells and/or the number of first groups and/or the number of first combinations of a PDCCH that the terminal equipment is able to monitor. In performing related configuration, the network device may reference to the capabilities of the terminal equipment. For example, the network device may reference to the capabilities of the terminal equipment in configuring M_{PDCCH}^{max,T}^{ᵤₙᵢₜ}^{,μ}, M_{PDCCH}^{total,T}^{ᵤₙᵢₜ}^{,μ}, the fifth parameter and the sixth parameter.

How to allocate PDCCH candidates shall be described below.

In some embodiments, when the third parameter of the first search space is not less than the fourth parameter, the terminal equipment monitors the PDCCH candidates in the first search space. For example, the third parameter for the first set, or for the first cell in the first set, or for a second cell in the first set, or for the first group in the first set, or for the first combination in the first set, is not less than the fourth parameter. Hence, the PDCCH candidates may be monitored in the first search space.

For example, when M4 is less than or equal to M3 (e.g. the number of remaining PDCCH candidates that may be allocated is greater than or equal to the number of PDCCH candidates included in the first search space, and/or the number of remaining non-overlapped CCEs that may be allocated is greater than or equal to the number of non-overlapped CCEs included in the first search space), the PDCCH candidates may be monitored in the first search space, that is, the number of M4 PDCCH candidates used for monitoring may be allocated to the first search space.

In some embodiments, when the third parameter of the first search space is less than the fourth parameter, the terminal equipment monitors the PDCCH candidates in the first search space or does not monitor the PDCCH candidates in the first search space. For example, the third parameter for the first set, or for the first cell in the first set, or for a second cell in the first set, or for the first group in the first set, or for the first combination in the first set, is not less than the fourth parameter, and the PDCCH candidates are monitored in the first search space or the PDCCH candidates are not monitored in the first search space.

For example, when M4 is greater than M3 (e.g. the number of remaining PDCCH candidates that are able to be allocated is less than the number of PDCCH candidates included in the first search space, and/or the number of remaining non-overlapped CCEs that are able to be allocated is less than the number of non-overlapped CCEs included in the first search space), the PDCCH candidates are not monitored in the first search space, that is, no PDCCH candidate for monitoring is allocated for the first search space, or a zero number of PDCCH candidates is allocated to the first search space. FIG. 26 is a schematic diagram of allocating PDCCH candidates. As shown in FIG. 26, USS2 is the first search space, CSS, USS0 and USS1 are the search spaces before the first search space. A number N1 of PDCCH candidates has already been allocated for the CSS, a number N2 of PDCCH candidates has already been allocated for USS0, and a number N3 of PDCCH candidates has already been allocated for USS1. The number of PDCCH candidates that have already been allocated before the first search space is equal to N1+N2+N3=M2, the third parameter M3=M1−M2, M3 is less than M4, and the PDCCH candidates are not monitored on USS2.

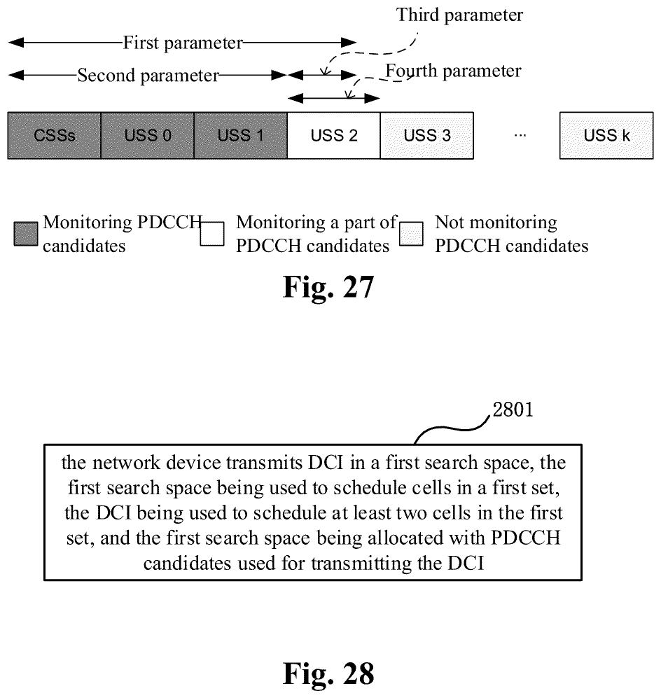

For example, for the case where the terminal equipment monitors the PDCCH candidates in the first search space, the terminal equipment monitors the PDCCH candidate of the third parameter in the first search space. That is, when M4 is greater than M3 (for example, the number of remaining PDCCH candidates that are able to be allocated is less than the number of PDCCH candidates included in the first search space, and/or the number of remaining non-overlapped CCEs that are able to be allocated is less than the number of non-overlapped CCEs included in the first search space), the PDCCH candidates may also be monitored in the first search space, that is, M3 PDCCH candidates used for monitoring are allocated to the first search space, or, in other words, M3 PDCCH candidates are monitored in the first search space. FIG. 27 is a schematic diagram of allocating PDCCH candidates. As shown in FIG. 27, USS2 is the first search space, CSS, USS0 and USS1 are the search spaces before the first search space. A number N1 of PDCCH candidates has already been allocated for the CSS, a number N2 of PDCCH candidates has already been allocated for USS0, and a number N3 of PDCCH candidates has already been allocated for USS1. The number of PDCCH candidates that have already been allocated before the first search space is equal to N1+N2+N3=M2, the third parameter M3=M1−M2, M3 is less than M4, and PDCCH candidates are monitored on USS2, but only M3 PDCCH candidates in USS2 are monitored.

It can be seen from the above embodiments that which PDCCH candidates are monitored in which search spaces may be determined for a case where one DCI schedules multiple cells, so as to support scheduling multiple cells by one DCI, thereby alleviating a burden of the terminal equipment in performing DCI monitoring, and lowering power consumption and complexity.

### Embodiments of a Second Aspect

The embodiments of this disclosure provide a data transmission method, which shall be described from a network device side, with parts repeated with those in the embodiments of the first aspect being not going to be described herein any further.

FIG. 28 is a schematic diagram of a data transmission method of the embodiments of this disclosure. As shown in FIG. 28, the method includes:
2801: the network device transmits DCI in a first search space, the first search space being used to schedule cells in a first set, the DCI being used to schedule at least two cells in the first set.

In some embodiments, the first search space is allocated with PDCCH candidates for transmitting the DCI. For example, the PDCCH candidates are allocated for one or more of the following: the first set, the first cell (in the first set), the second cell (in the first set), the first group (in the first set), the first combination (in the first set or the first group), and the set of the first combinations (in the first set or the first group).

Reference may be made to the embodiments of the first aspect for a mode for allocating PDCCH candidates, and 2801 corresponds to 401-402 in the embodiments of the first aspect, which shall not be repeated herein any further.

It can be seen from the above embodiments that which PDCCH candidates are monitored in which search spaces may be determined for a case where one DCI schedules multiple cells, so as to support scheduling multiple cells by one DCI, thereby alleviating a burden of the terminal equipment in performing DCI monitoring, and lowering power consumption and complexity.

### Embodiments of a Third Aspect

The embodiments of this disclosure provide a data reception apparatus. The apparatus may be, for example, a terminal equipment, or one or some components or assemblies configured in the terminal equipment. Contents in the embodiments identical to those in the embodiments of the first aspect shall not be described herein any further.

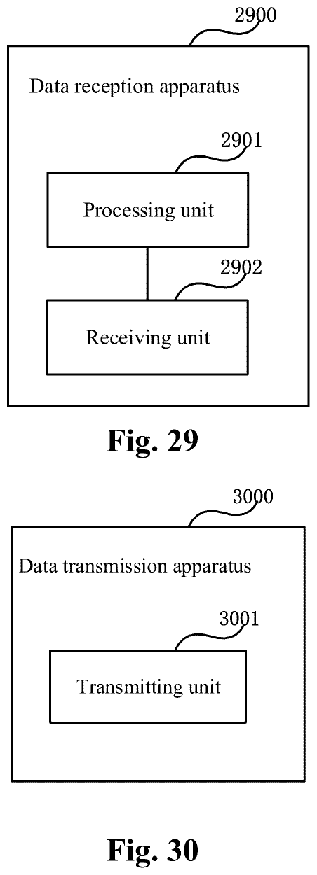

FIG. 29 is a schematic diagram of a data reception apparatus of the embodiments of this disclosure. As shown in FIG. 29, the apparatus includes:
a processing unit 2901 configured to allocate PDCCH candidates for a first search space, the first search space being used to schedule cells in a first set; and
a receiving unit 2902 configured to receive DCI in the first search space, the DCI being used to schedule at least two cells in the first set.

In some embodiments, the first search space is in a cell in the first cell set, or is not in any cell in the first cell set.

In some embodiments, the first search space includes a PDCCH candidate set, at least one PDCCH candidate in the PDCCH candidate set being used to transmit the DCI.

In some embodiments, the processing unit allocates PDCCH candidates for one or more of the following: the first set, a first cell (in the first set), a second cell (in the first set), a first group (in the first set), a first combination (in the first set or the first group), a set of first combinations (in the first set or the first group).

In some embodiments, the processing unit allocates the PDCCH candidates according to one or more of the following parameters: a first parameter, a second parameter, a third parameter, a fourth parameter, a fifth parameter, and a sixth parameter.

In some embodiments, the first parameter and/or the second parameter and/or the third parameter and/or the fourth parameter and/or the fifth parameter and/or the sixth parameter is/are for the first set, the first cell (in the first set), the second cell (in the first set), the first group (in the first set), the first combination (in the first set or the first group), the set of first combinations (in the first set or the first group).

In some embodiments, the first parameter denotes a first number of PDCCH candidates, the first number of PDCCH candidates being the number of PDCCH candidates that are able to be allocated, and/or,
the second parameter denotes a second number of PDCCH candidates, the second number of PDCCH candidates being the number of PDCCH candidates that have been allocated before the first search space, and/or,
the third parameter denotes a third number of PDCCH candidates, the third number of PDCCH candidates being the number of PDCCH candidates that are able to be allocated for the first search space, and/or,
the fourth parameter denotes a fourth number of PDCCH candidates, the fourth number of PDCCH candidates being the number of PDCCH candidates that are included in the first search space.

In some embodiments, the fifth parameter is used to determine the first parameter, and/or the sixth parameter is used to determine the fourth parameter, and the fifth parameter and the sixth parameter are identical or different.

In some embodiments, the fifth parameter and/or the sixth parameter is/are predefined or configured.

In some embodiments, the fifth parameter and/or the sixth parameter is/are related to the first group and/or the first combination.

In some embodiments, the apparatus further includes:
a first determining unit (not shown) configured to determine a first parameter for the first group according to the fifth parameter and/or the number of cells in the first group and/or the number of PDCCHs that are able to be allocated for a cell.

In some embodiments, the apparatus further includes:
a second determining unit (not shown) configured to determine a first parameter for the first combination according to the fifth parameter and/or the number of cells in the first combination and/or the number of PDCCHs that are able to be allocated for a cell.

In some embodiments, the PDCCH candidate set included in the first search space includes one or more first PDCCH candidate sets, wherein the first PDCCH candidate set is for the first set, or the first cell in the first set, or, a third cell in the first set, or a second cell group in the first set, or a second combination in the first set or the second group.

In some embodiments, the third cell is identical to or different from the second cell, and/or, the second group is identical to or different from the first group, and/or, the second combination is identical to or different from the first combination.

In some embodiments, different second groups or different second combinations include or do not include the same cell.

In some embodiments, different third cells are associated with or are not associated with the same cell.

In some embodiments, two first PDCCH candidate sets include or do not include PDCCH candidates with identical CCEs.

In some embodiments, the apparatus further includes:
a reporting unit (not shown) configured to report a capability of the terminal equipment, the capability including the number of cells and/or the number of first groups and/or the number of first combinations of a PDCCH that the terminal equipment is able to monitor.

In some embodiments, the allocating unit allocates PDCCH candidates for a first cell or a second cell or a first group in the first set, at least one cell in the first cell or the second cell or the first group being included in multiple second groups or second combinations, and fourth parameter for the first cell or the second cell or the first group being determined according to first PDCCH candidate sets to which the multiple second groups or second combinations correspond.

In some embodiments, the fourth parameter is equal to the number of PDCCH candidates in a union of the first PDCCH candidate sets to which the multiple second groups or second combinations correspond, or a sum of respective PDCCH candidates of the first PDCCH candidate sets to which the multiple second groups or second combinations correspond.

In some embodiments, the allocating unit allocates PDCCH candidates for the first group in the first set, the first group including multiple second groups or second combinations, and a fourth parameter for the first group is determined according to first PDCCH candidate sets to which the multiple second groups or second combinations correspond.

In some embodiments, the fourth parameter is equal to the number of PDCCH candidates in a union of the first PDCCH candidate sets to which the multiple second groups or second combinations correspond, or a sum of respective PDCCH candidates of the first PDCCH candidate sets to which the multiple second groups or second combinations correspond.

In some embodiments, the apparatus further includes:
a first monitoring unit (not shown) configured to, (for the first set, a first cell (in the first set), a second cell (in the first set), a first group (in the first set), a first combination (in the first set or the first group), a set of first combinations (in the first set or the first group), when a third parameter in the first search space is not less than a fourth parameter, monitor PDCCH candidates in the first search space.

In some embodiments, the apparatus further includes:
a second monitoring unit (not shown) configured to, when a third parameter of the first search space is less than a fourth parameter, monitor PDCCH candidates in the first search space or does not monitor the PDCCH candidate in the first search space.

In some embodiments, for a case where the terminal equipment monitors the PDCCH candidates in the first search space, the second monitoring unit monitors PDCCH candidates of a number of the third parameter in the first search space.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data reception apparatus 2900 may further include other components or modules, and reference may be made to related techniques for particulars of these components or modules.

Furthermore, for the sake of simplicity, connection relationships between the components or modules or signal profiles thereof are only illustrated in FIG. 29. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that which PDCCH candidates are monitored in which search spaces may be determined for a case where one DCI schedules multiple cells, so as to support scheduling multiple cells by one DCI, thereby alleviating a burden of the terminal equipment in performing DCI monitoring, and lowering power consumption and complexity.

### Embodiments of a Fourth Aspect

The embodiments of this disclosure provide a data transmission apparatus. The apparatus may be, for example, a network device, or one or some components or assemblies configured in the network device. Contents in the embodiments identical to those in the embodiments of the second aspect shall not be described herein any further.

FIG. 30 is a schematic diagram of a data transmission apparatus of the embodiments of this disclosure. As shown in FIG. 30, the apparatus includes:
a transmitting unit 3001 configured to transmit DCI in a first search space, the first search space being used to schedule cells in a first set, the DCI being used to schedule at least two cells in the first set.

In some embodiments, the first search space is allocated with PDCCH candidates for transmitting the DCI. For example, PDCCH candidates are allocated for one or more of the following: the first set, a first cell (in the first set), a second cell (in the first set), a first group (in the first set), a first combination (in the first set or the first group), a set of first combinations (in the first set or the first group).

Reference may be made to the embodiments of the first aspect for a mode for allocating the PDCCH candidates, and the transmitting unit 3001 corresponds to the receiving unit 2902 in the embodiments of the third aspect, with repeated parts being not going to be described herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data transmission apparatus 3000 may further include other components or modules, and reference may be made to related techniques for particulars of these components or modules.

Furthermore, for the sake of simplicity, connection relationships between the components or modules or signal profiles thereof are only illustrated in FIG. 30. However, it should be understood by those skilled in the art that such related techniques as bus connection, etc., may be adopted.

And the above components or modules may be implemented by hardware, such as a processor, a memory, a transmitter, and a receiver, etc., which are not limited in the embodiments of this disclosure.

It can be seen from the above embodiments that which PDCCH candidates are monitored in which search spaces may be determined for a case where one DCI schedules multiple cells, so as to support scheduling multiple cells by one DCI, thereby alleviating a burden of the terminal equipment in performing DCI monitoring, and lowering power consumption and complexity.

### Embodiments of a Fifth Aspect

The embodiments of this disclosure provide a communication system, and reference may be made to FIG. 1, with contents identical to those in the embodiments of the first to the fourth aspects being not going to be described herein any further.

In some embodiments, the communication system 100 may at least include: a terminal equipment 102 and/or a network device 101.

In some embodiments, reference may be made to the terminal equipment 3100 below for implementation of the terminal equipment 102, and reference may be made to a network device 3200 for implementation of the network device 101.

The embodiments of this disclosure further provide a network device, which may be, for example, a base station. However, this disclosure is not limited thereto, and it may also be another network device.

FIG. 32 is a schematic diagram of a structure of a network device of the embodiments of this disclosure. As shown in FIG. 32, the network device 3200 may include a processor 3210 (such as a central processing unit (CPU)) and a memory 3220, the memory 3220 being coupled to the processor 3210. The memory 3220 may store various data, and furthermore, it may store a program 3230 for information processing, and execute the program 3230 under control of the processor 3210.

For example, the processor 3210 may be configured to execute a program to carry out the data transmission method described in the embodiments of the second aspect.

Furthermore, as shown in FIG. 32, the network device 3200 may include a transceiver 3240, and an antenna 3250, etc. Functions of the above components are similar to those in the related art, and shall not be described herein any further. It should be noted that the network device 3200 does not necessarily include all the parts shown in FIG. 32, and furthermore, the network device 3200 may include parts not shown in FIG. 32, and the related art may be referred to.

The embodiments of this disclosure further provide a terminal equipment; however, this disclosure is not limited thereto, and it may also be another equipment.

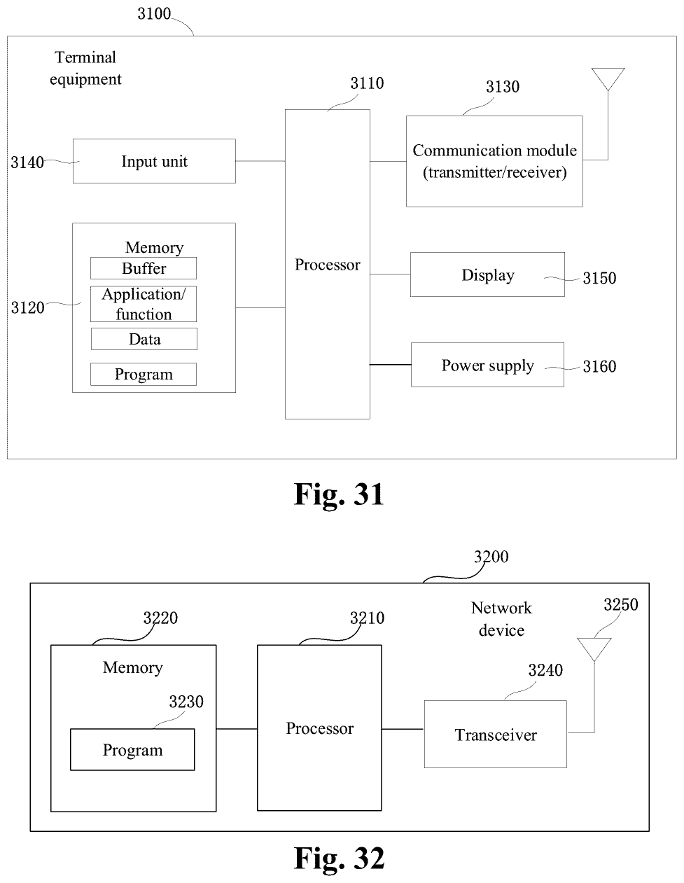

FIG. 31 is a schematic diagram of a terminal equipment of the embodiments of this disclosure. As shown in FIG. 31, a terminal equipment 3100 may include a processor 3110 and a memory 3120, the memory 3120 storing data and a program and being coupled to the processor 3110. It should be noted that this figure is illustrative only, and other types of structures may also be used, so as to supplement or replace this structure and achieve a telecommunications function or other functions.

For example, the processor 3110 may be configured to execute a program to carry out the data reception method as described in the embodiments of the first aspect.

As shown in FIG. 31, the terminal equipment 3100 may further include a communication module 3130, an input unit 3140, a display 3150, and a power supply 3160, wherein functions of the above components are similar to those in the related art, which shall not be described herein any further. It should be noted that the terminal equipment 3100 does not necessarily include all the parts shown in FIG. 31, and the above components are not necessary. Furthermore, the terminal equipment 3100 may include parts not shown in FIG. 31, and the related art may be referred to.

Embodiments of this disclosure provide a computer readable program, which, when executed in a terminal equipment, cause the terminal equipment to carry out the data reception method as described in the embodiments of the first aspect.

Embodiments of this disclosure provide a computer storage medium, including a computer readable program, which causes a terminal equipment to carry out the data reception method as described in the embodiments of the first aspect.

Embodiments of this disclosure provide a computer readable program, which, when executed in a network device, causes the network device to carry out the data transmission method as described in the embodiments of the second aspect.

Embodiments of this disclosure provide a computer storage medium, including a computer readable program, which causes a network device to carry out the data transmission method as described in the embodiments of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.
1. A data reception method, applicable to a terminal equipment, characterized in that the method includes:
allocating PDCCH candidates by the terminal equipment for a first search space, the first search space being used to schedule cells in a first set; and
receiving DCI by the terminal equipment in the first search space, the DCI being used to schedule at least two cells in the first set.
2. The method according to supplement 1, wherein,
the first search space is in a cell in the first cell set, or is not in any cell in the first cell set.
3. The method according to either one of supplements 1 and 2, wherein,
the first search space includes a PDCCH candidate set, at least one PDCCH candidate in the PDCCH candidate set being used to transmit the DCI.
4. The method according to any one of supplements 1-3, wherein the method further includes:
allocating PDCCH candidates by the terminal equipment for one or more of the following: the first set, a first cell (in the first set), a second cell (in the first set), a first group (in the first set), a first combination (in the first set or the first group), a set of first combinations (in the first set or the first group).
5. The method according to any one of supplements 1-5, wherein the method further includes:
allocating the PDCCH candidates according to one or more of the following parameters: a first parameter, a second parameter, a third parameter, a fourth parameter, a fifth parameter, and a sixth parameter.
6. The method according to supplement 5, wherein,
the first parameter and/or the second parameter and/or the third parameter and/or the fourth parameter and/or the fifth parameter and/or the sixth parameter is/are for the first set, the first cell (in the first set), the second cell (in the first set), the first group (in the first set), the first combination (in the first set or the first group), the set of first combinations (in the first set or the first group).
7. The method according to supplement 5 or 6, wherein,
the first parameter denotes a first number of PDCCH candidates, the first number of PDCCH candidates being the number of PDCCH candidates that are able to be allocated, and/or,
the second parameter denotes a second number of PDCCH candidates, the second number of PDCCH candidates being the number of PDCCH candidates that have been allocated before the first search space, and/or,
the third parameter denotes a third number of PDCCH candidates, the third number of PDCCH candidates being the number of PDCCH candidates that are able to be allocated for the first search space, and/or,
the fourth parameter denotes a fourth number of PDCCH candidates, the fourth number of PDCCH candidates being the number of PDCCH candidates that are included in the first search space.
8. The method according to supplement 5 or 6 or 7, wherein,
the fifth parameter is used to determine the first parameter, and/or the sixth parameter is used to determine the fourth parameter, and the fifth parameter and the sixth parameter are identical or different.
9. The method according to any one of supplements 5-8, wherein,
the fifth parameter and/or the sixth parameter is/are predefined or configured.
10. The method according to any one of supplements 5-9, wherein,
the fifth parameter and/or the sixth parameter is/are related to the first group and/or the first combination.
11. The method according to any one of supplements 4-10, wherein the method further includes:
determining a first parameter for the first group by the terminal equipment according to the fifth parameter and/or the number of cells in the first group and/or the number of PDCCHs that are able to be allocated for a cell.
12. The method according to any one of supplements 4-10, wherein the method further includes:
determining a first parameter for the first combination by the terminal equipment according to the fifth parameter and/or the number of cells in the first combination and/or the number of PDCCHs that are able to be allocated for a cell.
13. The method according to any one of supplements 1-12, wherein,
the PDCCH candidate set included in the first search space includes one or more first PDCCH candidate sets, wherein the first PDCCH candidate set is for the first set, or the first cell in the first set, or, a third cell in the first set, or a second cell group in the first set, or a second combination in the first set or the second group.
14. The method according to supplement 13, wherein,
the third cell is identical to or different from the second cell, and/or, the second group is identical to or different from the first group, and/or, the second combination is identical to or different from the first combination.
15. The method according to supplement 13 or 14, wherein,
different second groups or different second combinations include or do not include the same cell.
16. The method according to supplement 13, wherein,
different third cells are associated with or are not associated with the same cell.
17. The method according to supplement 13, wherein,
two first PDCCH candidate sets include or do not include PDCCH candidates with identical CCEs.
18. The method according to supplement 1, wherein the method further includes:
reporting a capability of the terminal equipment by the terminal equipment, the capability including the number of cells and/or the number of first groups and/or the number of first combinations of a PDCCH that the terminal equipment is able to monitor.
19. The method according to any one of supplements 1-18, wherein the method further includes:
allocating PDCCH candidates by the terminal equipment for a first cell or a second cell or a first group in the first set, at least one cell in the first cell or the second cell or the first group being included in multiple second groups or second combinations, and fourth parameter for the first cell or the second cell or the first group being determined according to first PDCCH candidate sets to which the multiple second groups or second combinations correspond.
20. The method according to supplement 19, wherein,
the fourth parameter is equal to the number of PDCCH candidates in a union of the first PDCCH candidate sets to which the multiple second groups or second combinations correspond, or a sum of respective PDCCH candidates of the first PDCCH candidate sets to which the multiple second groups or second combinations correspond.
21. The method according to any one of supplements 1-18, wherein the method further includes:
allocating PDCCH candidates by the terminal equipment for the first group in the first set, the first group including multiple second groups or second combinations, and determining a fourth parameter for the first group according to first PDCCH candidate sets to which the multiple second groups or second combinations correspond.
22. The method according to supplement 21, wherein the fourth parameter is equal to the number of PDCCH candidates in a union of the first PDCCH candidate sets to which the multiple second groups or second combinations correspond, or a sum of respective PDCCH candidates of the first PDCCH candidate sets to which the multiple second groups or second combinations correspond.
23. The method according to any one of supplements 1-18, wherein the method further includes:
(for the first set, a first cell (in the first set), a second cell (in the first set), a first group (in the first set), a first combination (in the first set or the first group), a set of first combinations (in the first set or the first group), when a third parameter in the first search space is not less than a fourth parameter, monitoring PDCCH candidates by the terminal equipment in the first search space.
24. The method according to any one of supplements 1-18, wherein the method further includes:
when a third parameter of the first search space is less than a fourth parameter, monitoring PDCCH candidates by the terminal equipment in the first search space or not monitoring the PDCCH candidate in the first search space.
25. The method according to supplement 24, wherein,
for a case where the terminal equipment monitors the PDCCH candidates in the first search space, the terminal equipment monitors PDCCH candidates of a number of the third parameter in the first search space.
26. A data transmission method, applicable to a network device, characterized in that the method includes:
transmitting DCI by the network device in a first search space, the first search space being used to schedule cells in a first set, the DCI being used to schedule at least two cells in the first set, and the first search space being allocated with PDCCH candidates for transmitting the DCI.
27. The method according to supplement 26, wherein PDCCH candidates are allocated for one or more of the following: the first set, a first cell (in the first set), a second cell (in the first set), a first group (in the first set), a first combination (in the first set or the first group), a set of first combinations (in the first set or the first group).
28. A network device, including a memory and a processor, the memory storing a computer program, and the processor being configured to execute the computer program to carry out the data transmission method as described in supplement 26 or 27.
29. A terminal equipment, including a memory and a processor, the memory storing a computer program, and the processor being configured to execute the computer program to carry out the data reception method as described in any one of supplements 1-25.
30. A communication system, including:
the terminal equipment as described in supplement 29, and/or the network device as described in supplement 28.

1. A data reception apparatus, applicable to a terminal equipment, the apparatus comprising:
processor circuitry configured to allocate PDCCH candidates for a first search space, the first search space being used to schedule cells in a first set; and
a transceiver configured to receive DCI in the first search space, the DCI being used to schedule at least two cells in the first set.

2. The apparatus according to claim 1, wherein,
the first search space includes a PDCCH candidate set, at least one PDCCH candidate in the PDCCH candidate set being used to transmit the DCI.

3. The apparatus according to claim 1, wherein the processor circuitry allocates PDCCH candidates for a second cell (in the first set).

4. The apparatus according to claim 1, wherein the processor circuitry allocates the PDCCH candidates according to one or more of the following parameters: a first parameter, a second parameter, a third parameter, and a fourth parameter.

5. The apparatus according to claim 4, wherein,
the first parameter and/or the second parameter and/or the third parameter and/or the fourth parameter is/are for the second cell (in the first set).

6. The apparatus according to claim 4, wherein,
the first parameter denotes a first number of PDCCH candidates, the first number of PDCCH candidates being the number of PDCCH candidates that are able to be allocated, and/or,
the second parameter denotes a second number of PDCCH candidates, the second number of PDCCH candidates being the number of PDCCH candidates that have been allocated before the first search space, and/or,
the third parameter denotes a third number of PDCCH candidates, the third number of PDCCH candidates being the number of PDCCH candidates that are able to be allocated for the first search space, and/or,
the fourth parameter denotes a fourth number of PDCCH candidates, the fourth number of PDCCH candidates being the number of PDCCH candidates that are included in the first search space.

7. The apparatus according to claim 4, wherein the processor circuitry allocates the PDCCH candidates according to one or more of the following parameters: a first parameter, a second parameter, a third parameter, a fourth parameter, a fifth parameter, and a six parameter;
wherein, the fifth parameter is used to determine the first parameter, and/or the sixth parameter is used to determine the fourth parameter, and the fifth parameter and the sixth parameter are identical or different.

8. The apparatus according to claim 3, wherein the processor circuitry allocates the PDCCH candidates for one or more of the following: the first set, a first cell (in the first set), a second cell (in the first set), a first group (in the first set), a first combination (in the first set or the first group), a first set of combinations (in the first set of the first group);
wherein a first parameter for the first group is determined according to a fifth parameter and/or the number of cells in the first group and/or the number of PDCCHs that are able to be allocated for a cell.

9. The apparatus according to claim 3, wherein the processor circuitry allocates the PDCCH candidates for one or more of the following: the first set, a first cell (in the first set), a second cell (in the first set), a first group (in the first set), a first combination (in the first set or the first group), a set of first combinations (in the first set of the first group);
wherein a first parameter for the first combination is determined according to a fifth parameter and/or the number of cells in the first combination and/or the number of PDCCHs that are able to be allocated for a cell.

10. The apparatus according to claim 1, wherein,
a PDCCH candidate set included in the first search space includes one or more first PDCCH candidate sets, wherein the first PDCCH candidate set is for the first set, or a first cell in the first set, or, a third cell in the first set, or a second group in the first set, or a second combination in the first set or the second group.

11. The apparatus according to claim 10, wherein,
two first PDCCH candidate sets include or do not include PDCCH candidates with identical CCEs.

12. The apparatus according to claim 1, wherein the transceiver reports a capability of the terminal equipment, the capability including the number of cells and/or the number of first groups and/or the number of first combinations of a PDCCH that the terminal equipment is able to monitor.

13. The apparatus according to claim 1, wherein the processor circuitry allocates PDCCH candidates for a first cell or a second cell or a first group in the first set, at least one cell in the first cell or the second cell or the first group being included in multiple second groups or second combinations, and a fourth parameter for the first cell or the second cell or the first group being determined according to first PDCCH candidate sets to which the multiple second groups or second combinations correspond.

14. The apparatus according to claim 13, wherein,
the fourth parameter is equal to the number of PDCCH candidates in a union of the first PDCCH candidate sets to which the multiple second groups or second combinations correspond, or a sum of respective PDCCH candidates of the first PDCCH candidate sets to which the multiple second groups or second combinations correspond.

15. The apparatus according to claim 1, wherein the processor circuitry allocates PDCCH candidates for a first group in the first set, the first group including multiple second groups or second combinations, and a fourth parameter for the first group is determined according to first PDCCH candidate sets to which the multiple second groups or second combinations correspond.

16. The apparatus according to claim 15, wherein the fourth parameter is equal to the number of PDCCH candidates in a union of the first PDCCH candidate sets to which the multiple second groups or second combinations correspond, or a sum of respective PDCCH candidates of the first PDCCH candidate sets to which the multiple second groups or second combinations correspond.

17. The apparatus according to claim 1, wherein the processor circuitry, (for the first set, a first cell (in the first set), a second cell (in the first set), a first group (in the first set), a first combination (in the first set or the first group), a set of first combinations (in the first set or the first group), when a third parameter in the first search space is not less than a four parameter, monitors PDCCH candidates in the first search space.

18. The apparatus according to claim 1, wherein the processor circuitry when a third parameter of the first search space is less than a fourth parameter, monitors PDCCH candidates in the first search space or does not monitor the PDCCH candidate in the first search space.

19. The apparatus according to claim 18, wherein,
for a case where the terminal equipment monitors the PDCCH candidates in the first search space, the processor circuitry monitors PDCCH candidates of a number of the third parameter in the first search space.

20. A data transmission apparatus, applicable to a network device, the apparatus comprising:
processor circuitry; and
a transmitter configured to transmit DCI in a first search space, the first search space being used to schedule cells in a first set, the DCI being used to schedule at least two cells in the first set, and the first search space being allocated with PDCCH candidates for transmitting the DCI.
